(19) United States
(12) Patent Application Publication
(10) Pub. No.: US 2002/0099813 A1
(43) Pub. Date: Jul. 25, 2002

(54) Method for collecting statistics about Web site usage

(76) Inventor: Jason Winshell, San Francisco, CA (US)

Correspondence Address: The Law Offices of Calvin B. Ward, Suite 305, 18 Crow Canyon Court, San Ramon, CA, 94583, US

(21) Appl. No.: 09/729,757

(22) Filed: Dec. 4, 2000

(51) Int. Cl. G06F 15/173; G06F 15/16

(52) U.S. Cl. 709/224; 709/203

(57) ABSTRACT

An improved method for operating a computer system that receives URL messages, each message having a path portion and a query portion. Each message conforms to a set of syntax rules. Copies of the received messages are stored in log files having a predetermined format. The computer system includes a program for counting the number of times messages having a unique path portion are present in one of the log files. In the method of the present invention, a rule is provided that includes data specifying a path and a query parameter. Each URL message received by the computer system is examined to determine if the path portion of that URL is the same as the path specified in the rule. If the path portion matches the specified path, a re-written URL message is generated by moving the query parameter specified in the rule from the query portion of that URL to the path portion of the URL. The re-written URL message is then stored in a first one of the log files. The counting program is then run with this first log file as input. In one embodiment of the invention, the URL message in an existing log file are examined and messages in which the path matches the rule are re-written to create a log file that is then processed by the counting program.

### FIELD OF THE INVENTION

The present invention relates to computer servers for use on the Internet, and more particularly, to a method for altering URL requests to allow existing statistical analysis programs to provide more meaningful data.

### BACKGROUND OF THE INVENTION

A computer user on the Internet often extracts information from a Web site by sending a message, referred to as a URL, to a server that hosts that Web site. The owner of the Web site often has an interest in keeping track of the requests made of the site. For example, in some instances, the owner of the Web site is paid money each time a particular piece of information is sent out to a user. In other cases, the Web site may return information about products sold by the owner. In such cases, the owner wishes to know the frequency with which information about each product is requested. Such information helps the owner understand which products are of most interest to the public.

Statistical analysis programs that generate information about the requests serviced by the server are well known. These programs are typically operated off of server log files that store the various URLs received by the server. The programs count the number of times a particular “path” is included in the logged URLs. Unfortunately, these programs do not provide the most useful statistics when the URLs relate to dynamically generated Web pages.

Consider a Web site that can search for and display information about cars. Assume that the site has a page that lists all the car models made by any manufacturer. For example, the page may display a list of all the models made by a manufacturer sorted by model name, category, and base-price. The page the user sees might look something like this:

Models made by “Ford”

| model | category | base price |
|---|---|---|
| Focus | compact | $15,000 |
| Explorer | SUV | $30,000 |
| Mustang | sport | $20,000 |

In principle, the page could be stored on the server in hypertext markup language (HTML) exactly as shown. A similar page could be stored for Chevrolet, and so on. However, such a scheme would be difficult to maintain, since the information changes with time, and hence, the Web pages would have to be re-written each time there was a model or price change.

Modern servers overcome this problem by utilizing dynamic Web pages. In a dynamic Web page, the HTML page is generated by the server at the time the URL is received. For example, the server may include a prototype page with “blanks” that are filled in from the data returned from a database in response to a query that is included in the URL sent by the user. The URL for the page discussed above might be:

http://www.somesite.com/ManufacturerModels.html?make=Ford&sortby=model_name′

The ‘http://’ is referred to as the protocol part of the URL. The “www.somesite.com” is the host part of the URL. The “/ManufacturerModels.html” is the path part of the URL, and the “?make=Ford&sortby=model_name” is the query part of the URL. The “make=Ford′” is a query parameter, the name of the parameter which selects records for which the parameter “make” has the value is “Ford”. The “sortby=model_name”′ is another query parameter. This parameter instructs the database how to sort the results.

To simply the following discussion, the protocol and host part of URLs will be omitted in the following discussion. A URL for the Web page showing the list of car models made by Ford sorted by the model name of the car would look like:

/ManufacturerModels.html?make=Ford&sortby=model_name,

while a URL for the Web page showing the list of car model's made by GM sorted by the price of the car would look like:

/ManufacturerModels.html?make=GM&sortby=base_price

When the user makes a request to view a particular URL from his or her Web browser the following sequence of steps occur to deliver the page back to the browser. First, the browser on the user's computer sends a URL to the Web site through Internet/Networking infrastructure.

Second, the Web server records the URL request into an access log in a standardized format. For example, the records in the log might look like:

192.168.0.1—[11/Sep/2000:16:55:00 -0700] “GET /ManufacturerModels.html?make=Ford&sortby=model_name HTTP/1.0” 200 15606

192.168.0.1—[11/Sep/2000:16:55:10 -0700] “GET /ManufacturerModels.html?make=Ford&sortby=base_price HTTP/1.0” 200 15606

192.168.0.2—[11/Sep/2000:16:56:00 -0700] “GET /ManufacturerModels.html?make=GM&sortby=base_price HTTP/1.0” 200 20202

192.168.0.2—[11/Sep/2000:16:56:10-0700] “GET /ManufacturerModels.html?make=GM&sortby=category HTTP/1.0” 200 20202

192.168.0.2—[11/Sep/2000: 16:57:10 -0700] “GET/SomeotherPage.html HTTP/1.0” 200 1022

The log entry typically includes the IP address of the server having the requested page, a time-stamp, the URL with protocol and host omitted, the result error code, and number of bytes transmitted in the response.

Third, in the case of a dynamic Web site, the Web server passes the URL request to the software that constructs the requested page. The dynamic construction software builds the page and returns the finished page back to the Web server. The Web server then sends the page to the browser via the Internet infrastructure.

As noted above, there are utilities that analyze the log entries to provide statistics on server usage. This software is available from many vendors and generates reports on Web site statistics by analyzing the contents of standardized Web server access logs. One particularly useful statistic is the number of times a particular page has been requested. Page count statistics are typically computed by tallying the number of times a URL with a unique “path” part occurs over a given time period. While the analysis software uses the path part of the URL as the unique identifier for the page, it ignores the query part, since tallying by path and query could produce an enormous number of unique page names if the possible values of query parameters is large. In the case of the our example URLs written into the log shown above, the analysis software would find 2 unique pages:

/ManufacturerModels.html, count=4

/SomeOtherPage.html, count=1

Hence, if one wanted to know the number of times that /ManufacturerModels.html was used to display “Ford” and “GM” car models separately, the standardized software is of little use, since the relevant information is not contained in the path part of the URL.

Broadly, it is the object of the present invention to provide an improved method for generating statistics on Web site usage.

It is a further object of the present invention to provide a method that allows existing statistics programs to generate statistics based on selected query data in the URL.

These and other objects of the present invention will become apparent to those skilled in the art from the following detailed description of the invention and the accompanying drawing.

### SUMMARY OF THE INVENTION

The present invention is an improved method for operating a computer system that receives URL messages, each message having a path portion and a query portion. Each message conforms to a set of syntax rules. Copies of the received messages are stored in log files having a predetermined format. The computer system includes a program for counting the number of times messages having a unique path portion are present in one of the log files. In the method of the present invention, a rule is provided that includes data specifying a path and a query parameter. Each URL message received by the computer system is examined to determine if the path portion of that URL is the same as the path specified in the rule. If the path portion matches the specified path, a re-written URL message is generated by moving the query parameter specified in the rule from the query portion of that URL to the path portion of the URL. The re-written URL message is then stored in a first one of the log files. The counting program is then run with this first log file as its input. In one embodiment of the invention, the URL message in an existing log file are examined and messages in which the path matches the rule are re-written to create a log file that is then processed by the counting program.

### BRIEF DESCRIPTION OF THE DRAWINGS

FIG. 1 is a flow chart for one embodiment of the present invention.

### DETAILED DESCRIPTION OF THE INVENTION

The present invention is based on the observation that the existing statistics software would perform the desired computations if the log entries were re-written so that the desired query information was part of the path. It should be noted that only part of the query information is desired, i.e., only those particular parameters that reveal the relevant data shown on the dynamically produced page. For example, in the case discussed above, one would want the “make” query parameter to be used to establish page identity. However, the “sortby” parameter is of little value.

In the preferred embodiment of the present invention, a program is run to postprocess Web logs after the Web server has written, but before the Web log anlaysis program is run. The program is utilized to re-write the URLs such that the desired portion of the query part of the URL is moved to the path portion of the URL. The program utilizes a set of rules provided by the Web site owner to determine the specific query parameters that are to be moved. A rule in this scheme is simply a list of the query parameter names that are to be moved when the URL contains a specified path.

The query part of the URL is all of the URL that follows the “?”. The goal of the re-writing program is to parse the query portion and remove each query parameter that matches the parameters in the rule. These parameters are then moved to the left of the “?” in the URL. To provide a means for reversing the transformation, a marker that identifies the moved portion of the query is inserted before the material that has been moved. In addition, the format of the rewritten URL must conform to the syntactic rules that all URLs must obey. Finally, the preprocessor must preserve any other URL or log entry data that is not to be moved in the rewriting process.

The manner in which the preferred embodiment of the present invention re-writes a URL can be more easily understood with reference to a simple example. Assume that the original URL has the form

/PathNameX?param_name1=value1&param_name2=value2&param_name3=value3, . . . ,&param_nameN=valueN

and assume that the rule for this path is of the form

PathNameX, param_name1, param_name3

That is, when the preprocessor finds a URL entry for PathNameX, it is to move query parameters “param_namel” and “param_name2” to the path portion of the URL entry. The re-written portion of the URL shown above would then become

/PathNameX/q/param_name1 =value1&param_name3=value3?param_name2=value2&, . . . . ,&param_nameN=valueN.

Here, the “/q/” marks the beginning of the query material that has been moved. Any program that normally reads URLs would see the rewritten URL as a legitimate URL referencing a path that includes a sub-directory “q”.

If the log entries shown above were re-written according to this embodiment of the present invention with the rule being “ManufacturerModels.html, make”, the log would be converted as follows:

192.168.0.1—[11/Sep/2000:16:55:00 -0700] “GET /ManufacturerModels.html/q/make=Ford?sortby=model_name HTTP/1.0” 200 15606

192.168.0.1—[11/Sep/2000:16:55:10 -0700] “GET /ManufacturerModels. html/q/make=Ford?sortby=base_price HTTP/1.0” 200 15606

192.168.0.2—[11/Sep/2000:16:56:00 -0700] “GET /ManufacturerModels.html/q/make=GM?sortby=base_price HTTP/1.0” 200 20202

192.168.0.2—[11/Sep/2000:16:56:10 -0700] “GET /ManufacturerModels.html/q/make=GM?sortby=category HTTP/1.0” 200 20202

192.168.0.2—[11/Sep/2000:16:57:10 -0700] “GET /SomeOtherPage.html HTTP/1.0” 200 1022

The last log entry for /SomeotherPage.html is unchanged since the path portion of this entry does not match the path in the rule.

If the conventional Web log analysis tools are run on the re-written log, the analysis tools would produce page counts as follows:

/ManufacturerModels. html/q/make=Ford, count=2

/ManufacturerModels.html/q/make=GM, count=2

/SomeOtherPage.html, count=1

It should be noted that rewriting the query parameters as “/q/param=value&param=value . . .” is only one possible rewriting notation. As long as the rewriting process makes copies of the parameter/values pairs as dictated by the rewriting rule into the path part of the URL as a syntactically legal URL, the existing Web log analysis routines will provide the desired page counts.

It should also be noted that the re-writing process is easily inverted to obtain the original URL. To convert the rewritten URL back to its original form, all the parameters following “/q/” to the end of the moved query string is moved to the right of the “?”. An “&” may be added as necessary. Then, the “/q/param=value&param=value . . .” is removed.

The above-described embodiments of the invention operate by re-writing the log to provide a modified log that is input to the page count analysis tools. However, other implementations may also be practiced without deviating from the teachings of the present invention. Any implementation will have a method for specifying a set of rewriting rules. Each rule will specify the path part of the URL to be matched in the original URL and the set of parameter names whose names and values are to be rewritten into the path part of the modified URL entry by the rewriting software. The rule set is specified by the end-user.

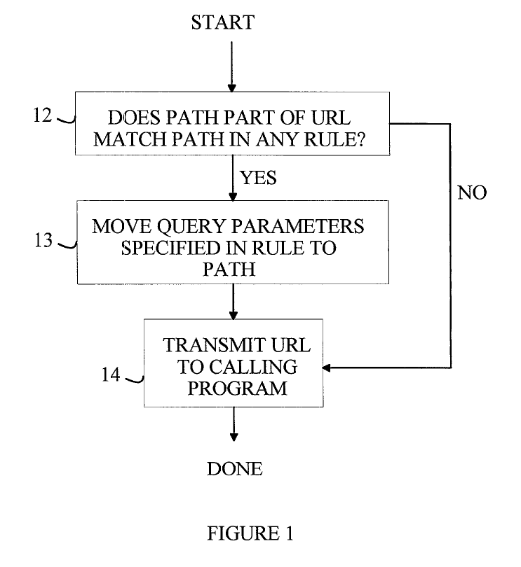

Refer now to FIG. 1, which is a flow chart for the rewriting software. The rewriting software, given an original URL in which all parameters appear in the query part of the URL will attempt to match the path part of the original URL against the a rule in the rule set as shown at 12. If the path part is matched by a rule in the set, the rewriting software outputs a rewritten URL in which the parameters identified in the rule are moved from the query part of the URL to the path portion as shown at 13. As noted above, the portion of the query that is moved is preferably marked in a manner that is consistent with the syntax rules governing URLs and that allows the material to be moved back to the query part at some subsequent point in the processing. If the path part of the URL is not matched by any rule, the rewriting software outputs the original URL unchanged to the calling program as shown at 14.

The re-writing can be performed at a number of points in the process of providing data in response to a URL. For example, as described above, the URL data can be re-written by post processing the Web logs to generate new logs that are then used as the input for the analysis tools. The post processing is preferably performed on log files that are not actively being written by a running Web server. A log file that is being actively written is difficult to process, since it is growing in size while the rewriting software is trying to read it. This embodiment of the present invention is the most general and flexible. It allows a set of log files to be processed through rewriting rules to produce a new set of log files. The process can be repeated using different rule sets if desired.

In another embodiment of the present invention, a branch point is inserted upstream of the code that returns the response to the URL in the conventional server. The inserted code intercepts each request and writes a parallel log file in which log entries have been rewritten. The branch code passes the original request, unchanged, to the software that returns the response to the URL. The result is two sets of log files, one in the original format, the other in the rewritten format.

In yet another embodiment of the present invention, the rewriting mechanism is integrated into the front-end of the application server or into the dynamic page construction mechanism. In this embodiment, the integrated software forces the browser to re-request a URL received in the standard query form that was matched by a rewriting rule. The re-requested URL would be in the rewritten form. For example if “/ManufacturerModels.html/make=Ford?sortby=model_name” was requested by the browser, the application server would force the URL to be re-requested as “/ManufacturerModels.html/q/make=Ford?sortby=model_name”. The extra re-request can be avoided if the <a> tag links generated on the dynamic constructed Web pages have their HREF attributes rewritten when the page is constructed. In this embodiment, if a rewritten URL is received, the software converts it back to the standard query form and handles the generation of the response as any other query form URL. The net effect of this method is that the standard set Web server log files contain all of the information needed for existing Web server log analysis tools to produce page counts based on rewritten URLs.

In a still further embodiment of the present invention, the rewriting code is inserted in the analysis tools as a conversion routine that alters the URLs as the analysis tools receive the URLs. The URLs may be received from a disk file. However, there are analysis tools that are inserted in the network upstream of the Web server. In this embodiment of the present invention, a patch is provided in the analysis routines to perform the rewriting of the URL prior to the point in the analysis routine at which the actual counting takes place.

Various modifications to the present invention will become apparent to those skilled in the art from the foregoing description and accompanying drawings. Accordingly, the present invention is to be limited solely by the scope of the following claims.

What is claimed is:

1. A method for operating a computer that receives URL messages, each such message having a path portion and a query portion, and each message conforming to a set of syntax rules, said method comprising the steps of:
providing a rule comprising data specifying a path and a query parameter;
examining a URL received by said computer to determine if said path portion of that URL is the same as said path specified in said rule; and
if said path portion matches said specified path, moving said query parameter specified in said rule from said query portion of that URL to said path portion of said URL.

2. The method of claim 1 wherein said moved query parameter is marked by a marker that is consistent with said syntax rules.

3. In a method for operating a computer system that receives URL messages, each such message having a path portion and a query portion, and each message conforming to a set of syntax rules, wherein copies of said received messages are stored in log files having a predetermined format, and wherein said computer system includes a program for counting the number of times messages having a unique path portion are present in one of said log files, the improvement comprising:
providing a rule comprising data specifying a path and a query parameter;
examining each URL message received by said computer system to determine if said path portion of that URL is the same as said path specified in said rule;
if said path portion matches said specified path, generating a re-written URL message by moving said query parameter specified in said rule from said query portion of that URL to said path portion of said URL; and
causing said re-written URL message to be stored in a first one of said log files.

4. The method of claim 3 further comprising the step of executing said counting program on said first log file.

5. The method of claim 3 wherein said step examining each URL message comprises examining each entry in a second one of said log files, said second log file containing copies of URL messages that had been previously received by said computer system.

6. The method of claim 3 wherein said step of examining each URL message is performed on each URL message received by said computer system prior to that URL message being stored in any of said log files.

7. The method of claim 3 wherein said URL message was sent by the browser connected to said computer system and wherein said step of causing said re-written URL message to be stored in said first log file comprises the step of causing said browser to re-submit a message that matches said re-written URL message.
